(19) United States
(12) Patent Application Publication
(10) Pub. No.: US 2017/0352914 A1
(43) Pub. Date: Dec. 7, 2017

(54) LITHIUM-COBALT-BASED COMPOSITE OXIDE AND METHOD FOR MANUFACTURING THE SAME, ELECTROCHEMICAL DEVICE AND LITHIUM ION SECONDARY BATTERY

(71) Applicant: SHIN-ETSU CHEMICAL CO., LTD., Tokyo (JP)

(72) Inventors: Hidekazu AWANO, Takasaki-shi (JP); Hiromichi KAMO, Takasaki-shi (JP); Takakazu HIROSE, Annaka-shi (JP); Hiroki YOSHIKAWA, Takasaki-shi (JP)

(73) Assignee: SHIN-ETSU CHEMICAL CO., LTD., Tokyo (JP)

(21) Appl. No.: 15/535,540

(22) PCT Filed: Nov. 24, 2015
(86) PCT No.: PCT/JP2015/005822

§ 371 Date: Jun. 13, 2017

(30) Foreign Application Priority Data
Dec. 25, 2014 (JP) 2014-262054

(51) Int. Cl. H01M 10/0525; C01G 51/00; H01M 4/525; C01G 53/00; H01G 11/68; H01M 4/02

(52) U.S. Cl. CPC H01M 10/0525; C01G 53/42; C01G 53/50; H01G 11/68; C01G 51/42; H01M 4/525; C01P 2002/50; H01M 2004/028; C01P 2006/40

(57) ABSTRACT

A lithium-cobalt-based composite oxide used for a positive electrode active material of an electrochemical device, wherein the lithium-cobalt-based composite oxide has elutable fluoride ions, the elutable fluoride ions being eluted to an eluate when the lithium-cobalt-based composite oxide is dispersed to ultrapure water, in a mass ratio of 500 ppm or more and 15000 ppm or less in comparison with the lithium-cobalt-based composite oxide, and the lithium-cobalt-based composite oxide has a composition shown by the following general formula (1): Li₁₋ₓCo_{1-z}M_{z}O₂₋ₐFₐ (−0.1≦x<1, 0≦z<1, 0≦a<2) . . . (1) (wherein, M represents one or more kinds of metal element selected from the group of Mn, Ni, Fe, V, Cr, Al, Nb, Ti, Cu, and Zn).

### TECHNICAL FIELD

The present invention relates to a lithium-cobalt-based composite oxide and a method for manufacturing the same, as well as an electrochemical device and a lithium ion secondary battery using the lithium-cobalt-based composite oxide.

### BACKGROUND ART

With the widespread diffusion of small-sized electronic devices such as a mobile terminal in recent years, further miniaturization, weight saving, and life-elongation of the electronic devices are highly required. For these market demands, development of secondary battery is proceeding, in particular a small-sized, light weight one which can achieve a high energy density. This secondary battery is also evaluated to apply to large-sized electronic devices such as an automobile, electricity storage systems such as a house, not only to small-sized electronic devices.

Above all, lithium ion secondary battery is greatly expected, since it is liable to achieve miniaturization and high capacity. This is also due to capability to give higher energy density compared to a lead battery or a nickel-cadmium battery.

This lithium ion secondary battery is provided with a positive electrode and a negative electrode, as well as a separator and an electrolytic solution. These positive electrode and negative electrode contain a positive electrode active material and a negative electrode active material which participate in charge/discharge reaction.

Non-aqueous electrolyte secondary batteries having lithium-cobalt composite oxide, the lithium-cobalt composite oxide having a layered rock salt structure of hexagonal system in the space group of R-3m and containing transition metal of rare metal such as cobalt and nickel, as the positive electrode active material have been. proposed conventionally. Such non-aqueous electrolyte secondary batteries are demanded to have higher capacity, together with cycle life at higher voltage in recent years. Regarding the cycle life, however, still more improvements are highly demanded, and various attempts have been performed (see Patent Documents 1 to 6, for example). These attempts include an attempt to stabilize a crystal structure of composite oxide of lithium with cobalt and nickel, which is active material, by forming a solid solution with other metal or semimetal elements in the composite oxide; and an attempt to adjust the amount of impurity elements such as sodium and potassium, but fail to achieve satisfactory cycle life.

### CITATION LIST

### Patent Literature

Patent Document 1: Japanese Unexamined Patent Application publication (Kokai) No. 2014-075177

Patent Document 2: Japanese Unexamined Patent Application publication (Kokai) No. 2009-026640

Patent Document 3: Japanese Unexamined Patent Application publication (Kokai) No. 2007-048525

Patent Document 4: Japanese Unexamined Patent Application publication (Kokai) No. 2012-079603

Patent Document 5: Japanese Unexamined Patent Application publication (Kokai) No. 2005-019244

Patent Document 6: Japanese Unexamined Patent Application publication (Kokai) No. 2013-157260

### SUMMARY OF INVENTION

### Problem to be Solved by the Invention

The present invention was accomplished in view of the above-described problems. It is an object of the present invention to provide a lithium-cobalt-based composite oxide that gives higher charge discharge capacity and higher cycle characteristics when it is used as a positive electrode active material for an electrochemical device, together with a method for producing the same.

### Means for Solving Problem

To achieve the above-described object, the present invention provides a lithium-cobalt-based composite oxide used for a positive electrode active material of an electrochemical device,
wherein the lithium-cobalt-based composite oxide has elutable fluoride ions, the elutable fluoride ions being eluted to an eluate from the lithium-cobalt-based composite oxide when the lithium-cobalt-based composite oxide is dispersed to ultrapure water, in a mass ratio of 500 ppm or more and 15000 ppm or less in comparison with the lithium-cobalt-based composite oxide, and
the lithium-cobalt-based composite oxide has a composition shown by the following general formula (1):

Li₁₋ₓCo_{1-z}M_{z}O₂₋ₐFₐ (−0.1≦x<1, 0≦z<1, 0≦a<2) (1)

(wherein, M represents one or more kinds of metal element selected from the group of Mn, Ni, Fe, V, Cr, Al, Nb, Ti, Cu, and. Zn).

Such a lithium-cobalt-based composite oxide allows lithium ions to eliminate and insert smoothly to stably supply lithium ions appropriately. This makes it possible to achieve higher charge/discharge capacity and higher cycle characteristics when the composite oxide is used as a positive electrode active material for an electrochemical device.

It is preferable that the lithium-cobalt-based composite oxide has elutable lithium ions, the elutable lithium ions being eluted to an eluate from the lithium-cobalt-based composite oxide when the lithium-cobalt-based composite oxide is dispersed to ultrapure water, in a mass ratio of 500 ppm or more and 20000 ppm or less in comparison with the lithium-cobalt-based composite oxide.

If the mass ratio of lithium ions eluted in the eluate is in the foregoing range in comparison with the lithium-cobalt-based composite oxide when the lithium-cobalt-based composite oxide is dispersed into ultrapure water, it is possible to improve the charge/discharge capacity and the cycle characteristics of an electrochemical device more effectively when the composite oxide is used as the positive electrode active material of the electrochemical device.

It is preferable that the lithium-cobalt-based composite oxide have elutable lithium ions and the elutable fluoride ions, the elutable lithium ions and the elutable fluoride ions being eluted to an eluate from the lithium-cobalt-based composite oxide dispersed to ultrapure water, in a mass ratio (the mass of the fluoride ions/the mass of the lithium ions) of 0.1 or more and 5 or less.

When the mass ratio of elutable lithium ions and the fluoride ions (the mass of the fluoride ions/the mass of the lithium ions) is in the foregoing range, it is possible to improve the charge/discharge capacity and the cycle characteristics of an electrochemical device more surely when the composite oxide is used as the positive electrode active material of the electrochemical device.

It is preferable that the lithium-cobalt-based composite oxide has an average particle size of 0.5 μm or more and 30.0 μm or less.

When the average particle size of the lithium-cobalt-based composite oxide is in the foregoing range, it is possible to improve the charge/discharge capacity and the cycle characteristics of an electrochemical device more effectively when the composite oxide is used as the positive electrode active material of the electrochemical device.

It is preferable that the lithium-cobalt-based composite oxide has a BET specific surface area of 0.10 m²/g or more and 2.00 m²/g or less.

When the BET specific surface area of the lithium-cobalt-based composite oxide is in the foregoing range, it is possible to improve the charge/discharge capacity and the cycle characteristics of an electrochemical device more effectively when the composite oxide is used as the positive electrode active material of the electrochemical device.

The present invention also provides a method for producing a lithium-cobalt-based composite oxide having a composition shown by the following general formula (1):

Li₁₋ₓCo_{1-z}M_{z}O₂₋ₐFₐ (−0.1≦x<1, 0≦z<1, 0≦a<2) (1)

(wherein, M represents one or more kinds of metal element selected from the group of Mn, Ni, Fe, V, Cr, Al, Nb, Ti, Cu, and Zn), comprising the step of:
mixing and then reacting a lithium compound and a lithium-cobalt-based composite oxide-precursor which has a composition shown by the following general formula (2) with the lithium being extracted:

Li_{1-y}Co_{1-z}M_{z}O_{2-b}F_{b} (x<y≦1, 0≦z<1, 0≦b<2) (2)

(wherein, M represents one or more kinds of metal element selected from the group of Mn, Ni, Fe, V, Cr, Al, Nb, Ti, Cu, and Zn),
wherein, by using as the lithium-cobalt-based composite oxide-precursor and/or the lithium compound the precursor and/or the compound containing fluorine, the produced lithium-cobalt-based composite oxide has elutable fluoride ions, the elutable fluoride ions being eluted to an eluate when the produced lithium-cobalt-based composite oxide is dispersed to ultrapure water, in a mass ratio of 500 ppm or more and 15000 ppm or less in comparison with the lithium-cobalt-based composite oxide.

By using such a production method, the produced lithium-cobalt-based composite oxide can achieve higher charge/discharge capacity and higher cycle characteristics of an electrochemical device when the composite oxide is used as the positive electrode active material of the electrochemical device. Therefore, it is possible to produce at low cost a lithium-cobalt based composite oxide in which higher charge/discharge capacity and higher cycle characteristics can be obtained when it is used as a positive electrode active material of an electrochemical device.

The lithium-cobalt-based composite oxide-precursor is preferably a lithium-cobalt-based composite oxide-precursor in which the lithium is extracted electrochemically.

Such a method can be suitably used as a method to extract the lithium.

The lithium-cobalt-based composite oxide-precursor is preferably a lithium-cobalt-based composite oxide-precursor in which the lithium is extracted electrochemically after molding the lithium-cobalt-based composite oxide-precursor so as to have a thickness of 1.0 mm or more.

Such a method also can be suitably used as a method to extract the lithium.

The foregoing lithium compound preferably contains lithium hexafluorophosphate (LiPF₆).

It is possible to add fluorine to the lithium-cobalt-based composite oxide by using a lithium compound that contains lithium hexafluorophosphate as the lithium compound to be reacted with the lithium-cobalt-based composite oxide-precursor.

The foregoing lithium compound preferably contains lithium tetrafluoroborate (LiBF₄).

It is possible to add fluorine to the lithium-cobalt-based composite oxide by using a lithium compound that contains lithium tetrafluoroborate as the lithium compound to be reacted with the lithium-cobalt-based composite oxide-precursor.

It is preferable that the reacting step includes a baking stage, and in the baking stage, the baking temperature is 600° C. or more and 1100° C. or less.

The method to perform baking in the foregoing temperature region can be suitably used as the method to react the lithium compound and the lithium-cobalt-based composite oxide-precursor.

It is preferable that the reacting step includes a baking stage, and the baking stage is performed in the atmosphere.

In the reaction of the lithium-cobalt-based composite oxide-precursor and the lithium compound, it is desirable to perform in the presence of oxygen. Therefore, the baking is preferably performed in the atmosphere, which contains oxygen. Further, the baking in the atmosphere removes necessity to adjust the baking atmosphere, and it is possible to reduce the production cost thereby.

The present invention further provides an electrochemical device, comprising:
a negative electrode composed of a negative electrode current collector and a negative electrode active material layer containing a particle of negative electrode active material that has charge/discharge efficiency of 80% or less when the particle of negative electrode active material is used as a negative electrode active material for the electrochemical device; and
a positive electrode composed of a positive electrode current collector and a positive electrode active material layer containing the lithium-cobalt-based composite oxide described above.

Such an electrochemical device can have higher charge/discharge capacity and higher cycle characteristics.

The present invention also provides an electrochemical device, comprising:
a negative electrode composed of a negative electrode current collector and a negative electrode active material layer containing a particle of negative electrode active material that contains silicon oxide shown by the composition formula of SiOₓ (0.5≦x<1.6);
a positive electrode composed of positive electrode current collector and a positive electrode active material layer containing the lithium-cobalt-based composite oxide described above.

Such an electrochemical device can have higher charge/discharge capacity and higher cycle characteristics.

The present invention also provides a lithium ion secondary battery, comprising:
a negative electrode composed of a negative electrode current collector and a negative electrode active material layer containing a particle of negative electrode active material that has charge/discharge efficiency of 80% or less when the particle of negative electrode active material is used as a negative electrode active material for the lithium ion secondary battery; and
a positive electrode composed of a positive electrode current collector and a positive electrode active material layer containing the lithium-cobalt-based composite oxide described above.

Such a lithium ion secondary battery can have higher charge/discharge capacity and higher cycle characteristics.

The present invention also provides a lithium ion secondary battery, comprising:
a negative electrode composed of a negative electrode current collector and a negative electrode active material layer containing a particle of negative electrode active material that contains silicon oxide shown by the composition formula of SiOₓ (0.5≦x<1.6); and
a positive electrode composed of a positive electrode current collector and a positive electrode active material layer containing the lithium-cobalt-based composite oxide described above.

Such a lithium ion secondary battery can have higher charge/discharge capacity and higher cycle characteristics.

### Effect of Invention

As described above, the inventive lithium-cobalt-based composite oxide allows lithium ions to eliminate and insert smoothly when the composite oxide is used as a positive electrode active material for an electrochemical device; which makes it possible to stably supply lithium ions appropriately, and can improve the charge/discharge capacity and the cycle characteristics thereby. When the inventive method for producing a lithium-cobalt-based composite oxide is used, it is possible to produce at low cost a lithium-cobalt based composite oxide in which higher charge/discharge capacity and higher cycle characteristics can be obtained when it is used as a positive electrode active material of an electrochemical device since this method enables a lithium-cobalt based composite oxide, even though it is regenerated from a spent positive electrode, to bring higher charge/discharge capacity and higher cycle characteristics when the composite oxide is used as the positive electrode active material of an electrochemical device. Furthermore, the inventive electrochemical device can have higher charge/discharge capacity and higher cycle characteristics. The inventive lithium ion secondary battery can have higher charge/discharge capacity and higher cycle characteristics.

### DESCRIPTION OF EMBODIMENTS

Hereinafter, the present invention will be specifically described as an example of the embodiment, but the present invention is not limited thereto.

As described above, non-aqueous electrolyte secondary batteries having lithium-cobalt composite oxide as the positive electrode active material have been proposed, and such non-aqueous electrolyte secondary batteries are desired to have higher capacity and cycle life at higher voltage. As for the cycle life, still more improvements are highly demanded, and various attempts for the improvement has been performed but failed to achieve satisfactory cycle life.

Accordingly, the present inventors have diligently investigated a lithium-cobalt-based composite oxide that can provide an electrochemical device with higher charge/discharge capacity and higher cycle characteristics when the composite oxide is used as the positive electrode active material of the electrochemical device. As a result, the present inventors have found that higher charge/discharge capacity and higher cycle characteristics can be obtained by using a lithium-cobalt-based composite oxide that has elutable fluoride ions, the elutable fluoride ions being eluted to an eluate when the lithium-cobalt-based composite oxide is dispersed to ultrapure water, in a mass ratio of 500 ppm or more and 15000 ppm or less in comparison with the lithium-cobalt-based composite oxide as a positive electrode active material for an electrochemical device; thereby bringing the present invention to completion.

First, the inventive lithium-cobalt-based composite oxide will be described.

The inventive lithium-cobalt-based composite oxide is a lithium-cobalt-based composite oxide used for a positive electrode active material of an electrochemical device,
wherein the lithium-cobalt-based composite oxide has elutable fluoride ions, the elutable fluoride ions being eluted to an eluate from the lithium-cobalt-based composite oxide when the lithium-cobalt-based composite oxide is dispersed to ultrapure water, in a mass ratio of 500 ppm or more and 15000 ppm or less, more preferably 1000 ppm or more and 15000 ppm or less, still more preferably 1500 ppm or more and 15000 ppm or less in comparison with the lithium-cobalt-based composite oxide, and
the lithium-cobalt-based composite oxide has a composition shown by the following general formula (1):

Li₁₋ₓCo_{1-z}M_{z}O₂₋ₐFₐ (−0.1≦x<1, 0≦z<1, 0≦a<2) (1)

(wherein, M represents one or more kinds of metal element selected from the group of Mn, Ni, Fe, V, Cr, Al, Nb, Ti, Cu, and Zn). Herein, “x” is more preferably 0≦x<0.5, still more preferably 0≦x<0.3; “z” is more preferably 0<z<0.7, still more preferably 0<z<0.4. That is, the lithium-cobalt-based composite oxide-precursor is more preferable when the cobalt content is larger. Because larger cobalt content makes it easier to obtain higher charge/discharge capacity and higher cycle characteristics.

In such a lithium-cobalt-based composite oxide, lithium ions can be eliminated and inserted smoothly, and lithium ions can be stably supplied appropriately. This makes it possible to achieve higher charge/discharge capacity and higher cycle characteristics when the composite oxide is used as a positive electrode active material for an electrochemical device. It is conceivable that the elutable fluoride ions are each contained in a form of LiF on the surface of the composite. In the present invention, however, it is important that the amount of fluoride ions be in the foregoing prescribed region when it is eluted as described above. The fluorine can be solid-solved in a base material in some case.

The lithium-cobalt-based composite oxide preferably has elutable lithium ions, the elutable lithium ions being eluted to an eluate when the composite is dispersed to ultrapure water, in a mass ratio of 500 ppm or more and 20000 ppm or less, more preferably 500 ppm or more and 15000 ppm or less, still more preferably 500 ppm or more and 10000 ppm or less in comparison with the lithium-cobalt-based composite oxide.

When the mass ratio of the elutable lithium ions, which are eluted to an eluate when the composite oxide is dispersed to ultrapure water, is in the foregoing range in comparison with the lithium-cobalt-based composite oxide, it is possible to improve the charge/discharge capacity and the cycle characteristics of an electrochemical device more effectively when the composite oxide is used as the positive electrode active material of the electrochemical device.

The lithium-cobalt-based composite oxide preferably has elutable lithium ions and the elutable fluoride ions, which are eluted to an eluate when the composite oxide is dispersed to ultrapure water, in a mass ratio (the mass of the fluoride ions/the mass of the lithium ions) of 0.1 or more and 5 or less, more preferably 0.3 or more and 4.5 or less, still more preferably 0.5 or more and 4.5 or less.

When the mass ratio of elutable lithium ions and the elutable fluoride ions (the mass of the fluoride ions/the mass of the lithium ions) is in the foregoing range, it is possible to improve the charge/discharge capacity and the cycle characteristics of an electrochemical device more surely when the composite oxide is used as the positive electrode active material of the electrochemical device.

The lithium-cobalt-based composite oxide preferably has an average particle size (median diameter) of 0.5 μm or more and 30.0 μm or less, more preferably 1 μm or more and 20 μm or less. Herein, the average particle size is on a volume basis.

When the average particle size of the lithium-cobalt-based composite oxide is in the foregoing range, it is possible to improve the charge/discharge capacity and the cycle characteristics of an electrochemical device more effectively when the composite oxide is used as the positive electrode active material of the electrochemical device.

The lithium-cobalt-based composite oxide preferably has a BET specific surface area of 0.10 m²/g or more and 2.00 m²/g or less, more preferably 0.10 m²/g or more and 1.5 m²/g or less, still more preferably 0.10 m²/g or more and 1.0 m²/g or less. Herein, the BET specific surface area means a surface area per a unit mass measured by BET method (a method in which gas particles of nitrogen and so on are absorbed to the solid particles, and the surface area is measured on the basis of the absorbed amount).

When the BET specific surface area of the lithium-cobalt-based composite oxide is in the foregoing range, it is possible to improve the charge/discharge capacity and the cycle characteristics of an electrochemical device more effectively when the composite oxide is used as the positive electrode active material of the electrochemical device.

The lithium-cobalt-based composite oxide described above allows lithium ions to eliminate and insert smoothly when the composite oxide is used as a positive electrode active material for an electrochemical device. This makes it possible to stably supply lithium ions appropriately, and can bring higher charge/discharge capacity and higher cycle characteristics thereby.

Subsequently, the inventive method for producing a lithium-cobalt-based composite oxide will be described.

The inventive method for producing a lithium-cobalt-based composite oxide is a method for producing a lithium-cobalt-based composite oxide having a composition shown by the following general formula (1):

Li₁₋ₓCo_{1-z}M_{z}O₂₋ₐFₐ (−0.1≦x<1, 0≦z<1, 0≦a<2) (1)

(wherein, M represents one or more kinds of metal element selected from the group of Mn, Ni, Fe, V, Cr, Al, Nb, Ti, Cu, and Zn), comprising the step of:
mixing and then reacting a lithium compound and a lithium-cobalt-based composite oxide-precursor that has a composition shown by the following general formula (2) with the lithium being extracted:

Li_{1-y}Co_{1-z}M_{z}O_{2-b}F_{b} (x<y≦1, 0≦z<1, 0≦b<2) (2)

(wherein, M represents one or more kinds of metal element selected from the group of Mn, Ni, Fe, V, Cr, Al, Nb, Ti, Cu, and Zn),
wherein, by using as the lithium-cobalt-based composite oxide-precursor and/or the lithium compound the precursor and/or the compound containing fluorine, the produced lithium-cobalt-based composite oxide has elutable fluoride ions, the elutable fluoride ions being eluted to an eluate when the produced lithium-cobalt-based composite oxide is dispersed to ultrapure water, in a mass ratio of 500 ppm or more and 15000 ppm or less in comparison with the lithium-cobalt-based composite oxide. Herein, “x” is more preferably 0≦x<0.5, still more preferably 0≦x<0.3; “y” is more preferably 0<y<0.8, still more preferably 0<y<0.6; “z” is more preferably 0<z<0.7, still more preferably 0<z<0.4. That is, the lithium-cobalt-based composite oxide-precursor is more preferable when the cobalt content is larger. Because larger cobalt content makes it easier to regenerate a spent positive electrode(s) and to obtain higher charge/discharge capacity and higher cycle characteristics.

By using such a production method, it is possible to produce at low cost a lithium-cobalt based composite oxide in which higher charge/discharge capacity and higher cycle characteristics can be obtained when it is used as a positive electrode active material of an electrochemical device since this method enables a lithium-cobalt based composite oxide, even though it is regenerated from a spent positive electrode, to bring higher charge/discharge capacity and higher cycle characteristics when the composite oxide is used as the positive electrode active material of an electrochemical device. Herein, the amount of the elutable fluoride ions can be controlled by adjusting the amount of fluorine-containing electrolytic solution when reacting a lithium compound and a lithium-cobalt-based composite oxide-precursor, for example. That is, the amount of the elutable fluoride ions can be controlled by adding and restoring the electrolytic solution when fluorine is deficient, and by releasing the electrolytic solution with using centrifugation and so on when fluorine is excess. The amount of the elutable lithium ions can be controlled by the amount of lithium source other than the electrolytic solution, baking temperature, etc. when the amount of the elutable fluoride ions is determined.

In the method for producing a lithium-cobalt-based composite oxide described above, the lithium-cobalt-based composite oxide-precursor, in which the lithium is extracted, includes the one taken out from a used electrode after charging and discharging by dissolving with organic solvent, the one in which the lithium is chemically extracted, the one in a state in which the lithium ions is dispersed by baking at a higher temperature, and the one in a state in which the lithium is extracted from powders or pellets by charging and discharging, for example. When using a lithium-cobalt-based composite oxide-precursor in which the lithium is partly removed, part of the lithium remains, which can form a lithium-cobalt-based composite oxide more easily, and can reduce the amount of the lithium compound to be used to produce a lithium-cobalt-based composite oxide at lower cost compared to the case of using coprecipitated raw material. The lithium-cobalt-based composite oxide-precursor of Li_{1-z}Co_{1-z}M_{z}O_{2-b}F_{b} may be regenerated from the state of LiCo_{1-z}M_{z}O_{2-b}F_{b} (y=0) returned to an original state by charging and discharging.

In the method for producing a lithium-cobalt-based composite oxide, the lithium-cobalt-based composite oxide-precursor is preferably a one in which the lithium is extracted electrochemically (specifically, by charging and discharging).

Such a method can be suitably used as a method to extract the lithium. Because this makes it easier to extract the lithium.

In the method for producing a lithium-cobalt-based composite oxide described above, it is preferable that the lithium-cobalt-based composite oxide-precursor is a lithium-cobalt-based composite oxide-precursor in which the lithium is extracted electrochemically after molding so as to have a thickness of 1.0 mm or more, more preferably 5.0 mm or more.

Such a method can be suitably used as a method to extract the lithium. Because the lithium-cobalt-based composite oxide-precursor has good handling when it is molded into the thickness described above.

In the method for producing a lithium-cobalt-based composite oxide described above, the lithium compound. includes lithium carbonate, lithium hydroxide, lithium oxide, lithium oxalate, lithium phosphate, lithium hexafluorophosphate, and lithium tetrafluoroborate, example; and is preferably lithium hydroxide, more preferably a mixture of lithium hydroxide and lithium hexafluorophosphate or a mixture of lithium hydroxide and lithium tetrafluoroborate, still more preferably a mixture of lithium hydroxide and lithium hexafluorophosphate.

Lithium hydroxide is particularly preferable, since it is industrially available with ease, highly reactive, and low cost. Lithium hexafluorophosphate and lithium tetrafluoroborate are good lithium conductor that is contained in an electrolyte solution as an electrolyte, and are ideal lithium compounds to achieve excellent charge/discharge capacity.

In the method for producing a lithium-cobalt-based composite oxide described above, it is preferable that the reacting step includes a baking stage, and the baking temperature is 600° C. or more and 1100° C. or less, more preferably 700° C. or more and 1100° C. or less, still more preferably 800° C. or more and 1100° C. or less in the baking stage.

The method to perform baking at the foregoing temperature range can be suitably used as a method for reacting the lithium-cobalt-based composite oxide-precursor and a lithium compound(s).

The baking time is preferably 1 hour or more and 50 hours or less, more preferably 2 hours or more and 15 hours or less, still more preferably 2 hours or more and 8 hours or less. It is preferable to perform a calcination step before the baking. The calcination temperature is preferably 150° C. or more and 450° C. or less, more preferably 200° C. or more and 300° C. or less; the calcination time is preferably 30 minutes or more and 5 hours or less, more preferably 2 hours or more and 5 hours or less.

The above-described baking is preferably performed in the atmosphere or an oxygen-containing atmosphere. The reaction of the lithium-cobalt-based composite oxide-precursor and the lithium compound is desirably performed in the presence of oxygen. Therefore, the baking preferably performed in the atmosphere, which contains oxygen, or in an oxygen-containing atmosphere. The baking in the atmosphere removes necessity to adjust the baking atmosphere, which can reduce the production cost, and is more preferable.

In the method for producing a lithium-cobalt-based composite oxide described above, the baking can also be performed with the combined use of other lithium-containing compound(s). This lithium-containing compound includes composite oxide containing lithium and a transition metal element(s), and phosphate compounds containing lithium and a transition metal element(s). Among these lithium-containing compounds, a compound that contains one or more kinds of nickel, iron, manganese, and cobalt is preferable. They can be represented by chemical formulae of Li_{c}MlO₂ and Li_{d}M2PO₄, for example. In the formulae, M1 and M2 each represent one or more transition metal elements; and the vales of “c” and “d”, which show different values in accordance with the state of charging and discharging of the battery, are generally represented by 0.05≦c≦1.1, 0.05≦d≦1.1. Illustrative examples of the composite oxide containing lithium and a transition metal element (s) include lithium-cobalt composite oxide (Li_{c}CoO₂) lithium-nickel composite oxide (Li_{c}NiO₂); and illustrative examples of the phosphate compounds containing lithium and a transition metal element(s) include lithium-iron phosphate compounds (Li_{d}FePO₄) and lithium-iron-manganese phosphate compounds (Li_{d}Fe₁₋ₑMnₑPO₄ (0<e<1)). Because they can give higher battery capacity, together with higher cycle properties.

In the method for producing a lithium-cobalt-based composite oxide described above, the lithium-cobalt-based composite oxide-precursor and the lithium compound may be mixed and reacted by using a method other than the baking or by combining the baking and another method(s). For example, it is possible to perform hydrothermal processing, to increase the number of baking, to perform palletization prior to the baking, etc. in the reaction.

By using the method for producing a lithium-cobalt-based composite oxide described above, it is possible to produce at low cost a lithium-cobalt based composite oxide in which higher charge/discharge capacity and higher cycle characteristics can be obtained when it is used as a positive electrode active material of an electrochemical device since this method enables a lithium-cobalt based composite oxide, even though it is regenerated from a spent positive electrode, to bring higher charge/discharge capacity and higher cycle characteristics when the composite oxide is used as the positive electrode active material of an electrochemical device.

The foregoing lithium-cobalt-based composite oxide can be utilized as a positive electrode active material for various electrochemical devices (e.g., a battery, a sensor, an electrolytic bath). Herein, the “electrochemical device” is a wording that refers to devices containing electrode plate material to flow current, that is, the whole of devices capable of bringing electric energy, and is a concept including an electrolytic bath, a primary battery, and a secondary battery. The “secondary battery” is a concept that includes so-called storage batteries such as a lithium ion secondary battery, a nickel-hydrogen battery, and a nickel-cadmium battery, as well as storage devices such as an electric double layer capacitor. The foregoing lithium-cobalt-based composite oxide is particularly suitable as an electrode material of a lithium ion secondary battery and an electrolytic bath. The electrolytic bath may be in any shape as far as it has electrode plate material to flow current. The lithium ion secondary battery can be in any shapes of coin, button, sheet, cylinder, and square shape. The inventive lithium-cobalt-based composite oxide can be applied to a lithium ion secondary battery for any use, which are not particularly limited, including electronic equipment such as a notebook computer, a laptop computer, a pocket-sized word processor, a cellular phone, a cordless phone, a portable CD player, and a radio, as well as consumer electronic equipment such as an automobile, an electric-powered vehicles, and a game player.

Hereinafter, each component of electrochemical devices and lithium ion secondary batteries in which the foregoing lithium-cobalt-based composite oxide is applied will be described.

### [Positive Electrode Active Material Layer]

The positive electrode active material layer preferably contains 50 to 100% by mass of the inventive lithium-cobalt-based composite oxide. It may also contain any one kind or two or more kinds of positive electrode active material(s) that can occlude and release lithium ions, as well as other materials such as a binder, a conductive assistant, and dispersing agent in accordance with the design.

### [Positive Electrode]

The positive electrode has the positive electrode active material layer(s) at the both sides or one side of a current collector, for example. The current collector can be formed by conductive material such as aluminum.

### [Negative Electrode Active Material Layer]

The negative electrode active material is preferably any of silicon oxide shown by the general formula of SiOₓ (0.5≦x<1.6) or a mixture of two or more of these. The negative electrode active material layer contain the negative electrode active material, and may contain other materials such as a binder, a conductive assistant, and dispersing agent in accordance with the design.

### [Negative Electrode]

The negative electrode has the same structure as the positive electrode described above, and has the negative electrode active material layer(s) at the both sides or one side of a current collector, for example. This negative electrode preferably has a larger negative electrode charge capacity compared to the electric capacity obtained from the positive electrode active material (a charge capacity as a battery). Because this can suppress deposition of lithium metal on a negative electrode.

### [Binder]

As the binder, it is possible to use any one or more of polymer materials, synthetic rubbers, etc. Illustrative examples of the polymer materials include polyvinylidene fluoride, polyimide, polyamide imide, aramid, polyacrylic acid, lithium polyacrylate, and carboxymethyl cellulose. Illustrative examples of the synthetic rubbers include styrene-butadiene rubber, fluorine rubber, and ethylene-propylene-diene.

### [Conductive Assistant]

As a positive electrode conductive assistant and a negative electrode conductive assistant, it is possible to use any one or more of carbon materials such as carbon black, acetylene black, graphite, ketjen black, carbon nanotube, carbon nanofiber.

### [Electrolytic Solution]

A separator or at least part of the active material layer is impregnated with liquid electrolyte (electrolytic solution). In this electrolytic solution, electrolyte salt is dissolved in solvent, and other materials such as additives can be contained. The solvent may be non-aqueous solvent. Illustrative examples of the non-aqueous solvent include ethylene carbonate, propylene carbonate, butylene carbonate, dimethyl carbonate, diethyl carbonate, ethyl methyl carbonate, methyl propyl carbonate, 1,2-dimethoxyethane, and tetrahydrofuran. Among them, it is preferable to use one or more of ethylene carbonate, propylene carbonate, dimethyl carbonate, diethyl carbonate, ethyl methyl carbonate, since better property can be obtained. In this case, more advantageous properties can be obtained by combining high-viscosity solvent such as ethylene carbonate and propylene carbonate, together with low-viscosity solvent such as dimethyl carbonate, ethyl methyl carbonate, and diethyl carbonate. Because this can improve the dissociation and ionic mobility of electrolyte salt.

It is particularly desirable that at least one kind of halogenated chain carbonate ester or halogenated cyclic carbonate ester is contained as the solvent. This makes it possible to form stable coat on the surface of the negative electrode active material during charge/discharge, especially during charge. The halogenated chain carbonate ester is chain carbonate ester having halogen as a constitutive element (at least one hydrogen is substituted with halogen). And the halogenated cyclic carbonate ester is cyclic carbonate ester having halogen as a constitutive element (at least one hydrogen is substituted with halogen).

Although the kind of halogen is not particularly limited, fluorine is more preferable, since it forms better coat compared to other halogens. As the number of halogen, the larger is better. Because this makes it possible to obtain more stable coat and to decrease decomposition reaction of the electrolytic solution. As the halogenated chain carbonate ester, fluoromethyl methyl carbonate, difluoromethyl methyl carbonate, etc. are illustrated As the halogenated cyclic carbonate ester, 4-fluoro-1,3-dioxolane-2-one, 4,5-difluoro-1,3-dioxolane-2-one, etc. are illustrated.

It is preferable to contain cyclic carbonate ester having an unsaturated carbon bond as an additive to the solvent. Because this makes it possible to form stable coat on the surface of the negative electrode during charge/discharge to suppress decompose reaction of the electrolytic solution. As the cyclic carbonate ester having an unsaturated carbon bond, vinylene carbonate, vinyletylene carbonate, etc. are illustrated. It is also preferable to contain sultone (cyclic sulfonic ester) as an additive to the solvent, since chemical stability of a battery is improved. As the sultone, for example, propane sultone and propene sultone are illustrated.

Furthermore the solvent preferably contains acid anhydride, since chemical stability of the electrolytic solution is improved. As the acid anhydride, for example, propane disulfonic anhydride is illustrated.

The electrolyte salt may contain any one or more of light metal salt such as lithium salt. As the lithium salt, for example, lithium hexafluorophosphate (LiPF₆), lithium tetrafluoroborate (LiBF₄) are illustrated. The content of the electrolyte salt is preferably 0.5 mol/kg or more and 2.5 mol/kg or less based on the solvent, since higher ion conductivity can be obtained.

### [Current Collector]

The current collector of the electrode is not particularly limited as far as it is an electronic conductive material that does not cause chemical change in the structured lithium ion secondary batteries and electrochemical devices. it is possible to use stainless steel, nickel, aluminum, titanium, baked carbon, and aluminum or stainless steel with the surface treated with carbon, nickel, copper, titanium, or silver, for example. Illustrative examples of the materials used for the negative electrode includes stainless steel, nickel, copper, titanium, aluminum, and baked carbon; as well as copper or stainless steel with the surface treated with carbon, nickel, titanium, or silver; and Al-Cd alloy.

### [Separator]

The separator is a one which separates a positive electrode and a negative electrode, and allows lithium ions to pass with preventing current short due to a contact of both electrodes. This separator is formed of a porous film consists of synthetic resin or ceramic, for example, and may contain a laminate structure in which two or more porous films are laminated. As the synthetic resin, polytetrafluoroethylene, polypropylene, polyethylene, etc. are illustrated, for example.

Subsequently, the inventive electrochemical device will be described.

The inventive electrochemical device is an electrochemical device, comprising:
a negative electrode composed of a negative electrode current collector and a negative electrode active material layer containing a particle of negative electrode active material that has charge/discharge efficiency of 80% or less when the particle of negative electrode active material is used as a negative electrode active material for the electrochemical device; and
a positive electrode composed of a positive electrode current collector and a positive electrode active material layer containing the lithium-cobalt-based composite oxide described above. Further, the inventive electrochemical device may also be an electrochemical device, comprising:
a negative electrode composed of a negative electrode current collector and a negative electrode active material layer containing a particle of negative electrode active material that contains silicon oxide shown by the composition formula of SiOₓ (0.5≦x<1.6); and
a positive electrode composed of a positive electrode current collector and a positive electrode active material layer containing the lithium-cobalt-based composite oxide described above. It is to be noted that the negative electrode and the positive electrode may be structured not to have a current collector.

Such an electrochemical device can have higher charge/discharge capacity and higher cycle characteristics.

It is to be noted that regenerated lithium-cobalt-based composite oxides tend to increase the powder resistance. The increase of powder resistance cause lowering of the charge/discharge efficiency. Accordingly, it is preferable to use a particle of negative electrode active material that has charge/discharge efficiency of 80% or less since this brings good balance of charge/discharge efficiency between the positive electrode and the negative electrode to give stable charge/discharge current.

Subsequently, the inventive lithium ion secondary battery will be described.

The inventive lithium ion secondary battery is a lithium ion secondary battery, comprising:
a negative electrode composed of a negative electrode current collector and a negative electrode active material layer containing a particle of negative electrode active material that has charge/discharge efficiency of 80% or less when the particle of negative electrode active material is used as a negative electrode active material for the lithium ion secondary battery; and
a positive electrode composed of a positive electrode current collector and a positive electrode active material layer containing the lithium-cobalt-based composite oxide described above. Further, the inventive lithium ion secondary battery may also be a lithium ion secondary battery, comprising:
a negative electrode composed of a negative electrode current collector and a negative electrode active material layer containing a particle of negative electrode active material that contains silicon oxide shown by the composition formula of SiOₓ (0.5≦x<1.6); and
a positive electrode composed of a positive electrode current collector and a positive electrode active material layer containing the lithium-cobalt-based composite oxide described above. It is to be noted that the negative electrode and the positive electrode may be structured not to have a current collector.

Such a lithium ion secondary battery can have higher charge/discharge capacity and higher cycle characteristics.

### EXAMPLES

Hereinafter, the present invention will be more specifically described by showing Examples and Comparative Examples, but the present invention is not limited thereto.

### Example 1

A pellet shaped Li_{0.5}CoO₂ (thickness: 15 mm), the lithium of which had been extracted in a button-shaped coin battery (CR2032) at constant current, was dried together with electrolytic solution containing lithium hexafluorophosphate (LiPF₆) as the electrolyte. This was lightly ground into powder and mixed with lithium carbonate (Li₂C₃) so as to have an equivalent ratio of Li/Co of 1.00/1.00. This mixture was baked in the atmosphere (at 800° C. for 5 hours), followed by cooling and pulverizing. Subsequently, this was classified with a sieve having an opening of 75 μm to produce a lithium-cobalt-based composite oxide having a composition of LiCoO₂.

### Example 2

A pellet shaped Li_{0.5}CoO₂ (thickness: 20 mm), the lithium of which had been extracted in an electrolytic bath at constant current, was dried together with electrolytic solution containing lithium hexafluorophosphate (LiPF₆) as the electrolyte. This was lightly ground into powder and mixed with lithium carbonate (Li₂CO₃) so as to have an equivalent ratio of Li/Co of 1.00/1.00. This mixture was baked in the atmosphere (at 850° C. for 3 hours), followed by cooling and pulverizing. Subsequently, this was classified with a sieve having an opening of 75 μm to produce a lithium-cobalt-based composite oxide having a composition of LiCoO₂.

### Example 3

A positive electrode plate was taken out from a lithium ion secondary battery that had been already used. The positive electrode active material applied on the aluminum foil was dissolved together with electrolytic solution containing lithium hexafluorophosphate (LiPF₆) as the electrolyte to separate Li_{0.5}CoO₂. The separated Li_{0.5}CoO₂ was filtered, dried, and lightly ground into powder. This powder was mixed with lithium carbonate (Li₂CO₃) so as to have an equivalent ratio of Li/Co of 1.00/1.00. This mixture was baked in the atmosphere (at 800° C. for 4 hours), followed by cooling and pulverizing. Subsequently, this was classified with a sieve having an opening of 75 μm to produce a lithium-cobalt-based composite oxide having a composition of LiCoO₂.

### Example 4

A positive electrode plate was taken out from a lithium ion secondary battery that had been already used. The positive electrode active material applied on the aluminum foil was dissolved in dimethyl carbonate (DMC) together with electrolytic solution containing lithium hexafluorophosphate (LiPF₆) as the electrolyte to separate Li_{0.5}CoO₂. The separated Li_{0.5}CoO₂ was filtered, dried, and lightly ground into powder. This powder was mixed with lithium carbonate (Li₂CO₃) so as to have an equivalent ratio of Li/Co of 1.00/1.00. This mixture was baked in the atmosphere (at 800° C. for 8 hours), followed by cooling and pulverizing. Subsequently, this was classified with a sieve having an opening of 75 μm to produce a lithium-cobalt-based composite oxide having a composition of LiCoO₂.

### Example 5

Powders of lithium carbonate (Li₂CO₃), cobalt oxide (particle size: 2 μm), and lithium hexafluorophosphate (LiPF₆) were mixed so as to have an equivalent ratio of Li/Co of 1.00/1.00. This mixture was baked in the atmosphere (at 800° C. for 10 hours), followed by cooling and pulverizing. Subsequently, this was classified with a sieve having an opening of 75 μm to produce a lithium-cobalt-based composite oxide having a composition of LiCoO₂.

### Example 6

Powders of lithium carbonate (Li₂CO₃), cobalt oxide (particle size: 2 μm), and lithium tetrafluoroborate (LiBF₄) were mixed so as to have an equivalent ratio of Li/Co of 1.00/1.00. This mixture was baked in the atmosphere (at 800° C. for 6 hours), followed by cooling and pulverizing. Subsequently, this was classified with a sieve having an opening of 75 μm to produce a lithium-cobalt-based composite oxide having a composition of LiCoO₂.

### Example 7

A pellet shaped Li_{0.5}Ni_{1/3}Mn_{1/3}Co_{1/3}O₂ (thickness: 20 mm), the lithium of which had been extracted in an electrolytic bath at constant current, was dried together with electrolytic solution containing lithium hexafluorophosphate (LiPF₆) as the electrolyte. This was lightly ground into powder and mixed with lithium carbonate (Li₂CO₃) so as to have an equivalent ratio of Li/(Ni+Mn+Co) of 1.05/1.00. This mixture was baked in the atmosphere (at 700° C. for 5 hours), followed by cooling and pulverizing. Subsequently, this was classified with a sieve having an opening of 75 μm to produce a lithium-cobalt-based composite oxide having a composition of LiNi_{1/3}Mn_{1/3}Co_{1/3}O₂.

### Example 8

A pellet shaped Li_{0.5}Ni_{1/3}Mn_{1/3}Co_{1/3}O₃ (thickness: 15 mm), the lithium of which had been extracted in an electrolytic bath at constant current, was dried together with electrolytic solution containing lithium hexafluorophosphate (LiPF₆) as the electrolyte. This was lightly ground into powder and mixed with lithium carbonate (Li₂Co₃) so as to have an equivalent ratio of Li/(Ni+Mn+Co) of 1.02/1.00. This mixture was baked in the atmosphere for about 5 hours (at 700° C. for 5 hours), followed by cooling and pulverizing. Subsequently, this was classified with a sieve having an opening of 75 μm to produce a lithium-cobalt-based composite oxide having a composition of LiNi_{1/3}Mn_{1/3}Co_{1/3}O₂.

### Example 9

A pellet shaped Li_{0.5}Ni_{0.5}Mn_{0.3}Co_{0.2}O₂ (thickness: 12 mm), the lithium of which had been extracted in a button-shaped coin battery (CR2032) at constant current, was washed with DMC, filtered, and dried. This was lightly ground into powder and mixed with powders of lithium carbonate (Li₂CO₃) and lithium hexafluorophosphate (LiPF₆) so as to have an equivalent ratio of Li/(Ni+Mn+Co) of 1.00/1.00. This mixture was baked in the atmosphere (at 750° C. for 5 hours), followed by cooling and pulverizing. Subsequently, this was classified with a sieve having an opening of 75 μm to produce a lithium-cobalt-based composite oxide having a composition of LiNi_{0.5}Mn_{0.3}Co_{0.2}O₂.

### Example 10

A pellet shaped Li_{0.5}Ni_{0.6}Mn_{0.2}Co_{0.2}O₂ (thickness: 10 mm), the lithium of which had been extracted in a button-shaped coin battery (CR2032) at constant current, was dried together with electrolytic solution containing lithium hexafluorophosphate (LiPF₆) as the electrolyte. This was lightly ground into powder and mixed with lithium carbonate (Li₂CO₃) so as to have an equivalent ratio of Li/(Ni+Mn+Co) of 1.00/1.00. This mixture was baked in the atmosphere (at 750° C. for 5 hours), followed by cooling and pulverizing. Subsequently, this was classified with a sieve having an opening of 75 μm to produce a lithium-cobalt-based composite oxide having a composition of LiNi_{0.6}Mn_{0.2}Co_{0.2}O₂.

### Example 11

A pellet shaped Li_{0.5}Ni_{0.8}Mn_{0.1}Co_{0.1}O₂ (thickness: 5 mm) the lithium of which had been extracted in a button-shaped coin battery (CR2032) at constant current, was dried together with electrolytic solution containing lithium hexafluorophosphate (LiPF6) as the electrolyte. This was lightly ground into powder and mixed with lithium hydroxide (LiOH·H₂O) so as to have an equivalent ratio of Li/(Ni+Mn+Co) of 1.02/1.00. This mixture was baked in O₂ gas (at 700° C. for 5 hours), followed by cooling and pulverizing. Subsequently, this was classified with a sieve having an opening of 75 μm to produce a lithium-cobalt-based composite oxide having a composition of LiNi_{0.8}MN_{0.1}Co_{0.1}O₂.

### Example 12

A pellet shaped Li_{0.5}Ni_{0.8}Al_{0.05}Co_{0.15}O₂ (thickness: 2 mm), the lithium of which had been extracted in a button-shaped coin battery (CR2032) at constant current, was washed with DMC, filtered, and dried. This was lightly ground into powder and mixed with powders of lithium hydroxide (LiOH·H₂O), lithium hexafluorophosphate (LiPF₆), and lithium tetrafluoroborate (LiBF₄) so as to have an equivalent ratio of Li/(Ni+Al+Co) of 1.00/1.00. This mixture was baked in O₂ gas (at 700° C. for 5 hours), followed by cooling and pulverizing. Subsequently, this was classified with a sieve having an opening of 75 μm to produce a lithium-cobalt-based composite oxide having a composition of LiNi_{0.8}Al_{0.05}Co_{0.15}O₂.

### Comparative Example 1

A pellet shaped. Li_{0.5}CoO₂ (thickness: 4 mm), the lithium of which had been extracted in a button-shaped coin battery (CR2032) at constant current, was washed with DMC, filtered, and dried. This was lightly ground into powder and mixed with powders of lithium carbonate (Li₂CO₃) and lithium hexafluorophosphate (LiPF₆) so as to have an equivalent ratio of Li/Co of 1.00/1.00. This mixture was baked in the atmosphere (at 900° C. for 0.5 hours), followed by cooling and pulverizing. Subsequently, this was classified with a sieve having an opening of 75 μm to produce a lithium-cobalt-based composite oxide having a composition of LiCoO₂.

### Comparative Example 2

A pellet shaped Li_{0.5}CoO₂ (thickness: 5 mm), the lithium of which had been extracted in a button-shaped coin battery (CR2032) at constant current, was washed with DMC, filtered, and dried. This was lightly ground into powder and mixed with lithium carbonate (Li₂CO₃) so as to have an equivalent ratio of Li/Co of 1.04/1.00. This mixture was baked in mixed gas of N₂-H₂ with the H₂ concentration of 5% (at 950° C. for 20 hours), followed by cooling and pulverizing. Subsequently, this was classified with a sieve having an opening of 75 μm to produce a lithium-cobalt-based composite oxide having a composition of LiCoO₂.

### Comparative Example 3

A pellet shaped Li_{0.5}CoO₂ (thickness: 6 mm), the lithium of which had been extracted in an electrolytic bath at constant current, was washed with DMC, filtered, and dried. This was lightly ground into powder and mixed with lithium carbonate (Li₂CO₃) so as to have an equivalent ratio of Li/Co of 1.03/1.00. This mixture was baked in the atmosphere (at 940° C. for 8 hours) , followed by cooling and pulverizing. Subsequently, this was classified with a sieve having an opening of 75 μm to produce a lithium-cobalt-based composite oxide having a composition of LiCoO₂.

### Comparative Example 4

A pellet shaped Li_{0.5}CoO₂ (thickness: 8 mm), the lithium of which had been extracted in a button-shaped coin battery (CR2032) at constant current, was washed with DMC, filtered, and dried. This was lightly ground into powder and mixed with lithium carbonate (Li₂CO₃) so as to have an equivalent ratio of Li/Co of 1.00/1.00. This mixture was baked in the atmosphere (at 650° C. for 8 hours), followed by cooling and pulverizing. Subsequently, this was classified with a sieve having an opening of 75 μm to produce a lithium-cobalt-based composite oxide having a composition of LiCoO₂.

### Comparative Example 5

A pellet shaped Li_{0.5}Ni_{0.8}Mn_{0.1}Co_{0.1}O₂ (thickness: 7 mm), the lithium of which had been extracted in a button-shaped coin battery (CR2032) at constant current, was washed with DMC and dried. This was lightly ground into powder and mixed with lithium hydroxide (LiOH·H₂O) and lithium hexafluorophosphate (LiPF₆) so as to have an equivalent ratio of Li/(Ni+Mn+Co) of 1.00/1.00. This mixture was baked in O₂ gas (at 650° C. for 8 hours), follower by cooling and pulverizing. Subsequently, this was classified with a sieve having an opening of 75 μm to produce a lithium-cobalt-based composite oxide having a composition of LiNi0.8Mn_{0.1}Co_{0.1}O₂. (Measurement of Mass of Fluorine ions and Lithium Ions Eluted into Ultrapure Water)

The mass of elutable fluorine ions and lithium ions, the elutable fluorine ions and lithium ions being eluted into ultrapure water when each lithium-cobalt-based composite oxide of Examples 1 to 12 and Comparative Examples 1 to 5 was dispersed to ultrapure water, were measured as described below. That is, when 1 g of each lithium-cobalt-based composite oxide powder is dispersed to 200 ml of ultrapure water at 25° C. for 5 minutes, the mass ratios of fluorine ions and lithium ions in dispersion in comparison with the lithium-cobalt-based composite oxide was measured by using high frequency inductively-coupled plasma (ICP) method and ion chromatography method. The measured values are represented by ppm in mass ratios in comparison with the lithium-cobalt-based composite oxide. The measured results of the amounts of fluorine ions and lithium ions eluted to ultrapure water are shown in Table 1. The ratios thereof (the mass of the fluoride ions/the mass of the lithium ions) are also shown in Table 1.

### (Measurement of Average Particle Size (Median Diameter)

The particle size distribution was measured on each lithium-cobalt-based composite oxide of Examples 1 to 12 and Comparative Examples 1 to 5 by using Microtrac MK-II (SRA) (LEED & NORTHRUP, laser scattering light detector type) and by using ion-exchange water as dispersion medium.

The following are dispersant, reflux volume, and ultrasonic output in the measurements of particle size distribution:
dispersant: 10% aqueous sodium hexametaphosphate 2 ml
reflux volume: 40 ml/sec
ultrasonic output: 40 W for 60 seconds

The measured results of average particle sizes are shown in Table 1.

### (Measurement of BET Specific Surface Area)

The BET specific surface area of each lithium-cobalt-based composite oxide of Examples 1 to 12 and Comparative Examples 1 to 5 was measured by using FlowSorb 2300 (manufactured by Shimadzu Corporation).

The measured results of BET specific surface areas are shown in Table 1.

### <Efficiency Tests of Batteries>

### (Preparation of Positive Electrode)

Positive electrode materials were prepared by mixing 95% by mass of each lithium-cobalt-based composite oxide of Examples 1 to 12 and Comparative Examples 1 to 5 produced as described above, 2.5% by mass of graphite powder, and 2.5% by mass of polyvinylidene fluoride. This was dispersed into N-methyl-2-pyrrolidinone (hereinafter, referred to as NMP) to prepare a mixed paste. The mixed paste was applied onto an aluminum foil and dried. This was pressed, whereby a disc with a diameter of 15 mm was punched out to give a positive electrode plate.

### (Preparation of Negative Electrode)

Then, an SiO negative electrode was prepared. A mixed raw material of metal silicon and silicon dioxide were introduced into a reaction furnace and deposited in an atmosphere of a vacuum of 10 Pa. After this was sufficiently cooled, the deposit was taken out and ground by a ball mill. The particle size was adjusted, and then covered with a carbon layer by thermal decomposition CVD. The prepared powder was subjected to inner-bulk reforming in a 1:1 mixed solvent of propylene carbonate and ethylene carbonate (electrolyte salt: 1.3 mol/Kg) using an electrochemical method. The obtained particle of negative electrode active material was subjected to drying treatment under a carbonic acid atmosphere. Subsequently, this particle of negative electrode active material, a precursor of a negative electrode binder, a conductive assistant 1 (ketjen black), and a conductive assistant 2 (acetylene black) were mixed in a dried-weight ratio of 80:8:10:2 to form a negative electrode material, and then diluted by NMP to form paste-state negative electrode material slurry. In this case, NMP was used as a solvent of polyamic acid (the precursor of the binder). Then the negative electrode material slurry was applied to a negative electrode current collector with using a coating apparatus, followed by drying. As this negative electrode current collector, electrolytic copper foil (thickness=15 μm) was used. Lastly, it was baked at 400° C. for 1 hour in a vacuum atmosphere, thereby forming a negative electrode binder (polyimide). After the baking, this was pressed, whereby a disc with a diameter of 16 mm was punched out to give a negative electrode plate.

### (Preparation of Coin-shaped Non-aqueous Electrolyte Secondary Battery)

A coin-shaped non-aqueous electrolyte secondary battery was prepared by using the prepared positive electrode plate and negative electrode plate, as well as each parts such as a separator, a current collector, metal attachment, outside terminals, and electrolytic solution. The electrolytic solution was prepared by dissolving 1 mole of LiPF₆ in 1 L of 2:7:1 mixed solvent of ethylene carbonate, didiethyl carbonate, and fluoroethylene carbonate.

### (Measurement or Discharge Capacity of Positive Electrode and Cycle Characteristics)

The coin-shaped lithium ion secondary battery prepared as described above was subjected to a charge/discharge test of charging to 4.00 V at a constant voltage and a constant current with using a current corresponding to 0.5 C for 5 hours and subsequent discharging to 2.5 V with using a current corresponding to 0.1 C, whereby the initial discharge capacity (mAh/g) of the positive electrode was measured. The results are shown in Table 1.

The foregoing charge/discharge was repeated 20 cycles to measure cycle characteristics defined as “[(the discharge capacity of the positive electrode at 20th cycles)/(the initial discharge capacity of the positive electrode)]×100 (%)”. These results are also shown in Table 1. Herein, the cycle characteristics mean the capacity retention ratio expressed in % when the electrode was used while flowing current repeatedly.

TABLE 1

| | | BET | | Cycle | | | | | | |
|---|---|---|---|---|---|---|---|---|---|---|
| | Average | specific | Dis- | char- | | | | | | |
| | particle | surface | charge | acter- | Baking | Baking | Eluted | Eluted | | Thickness |
| | size | area | capacity | istics | temp. | time | F | Li | | of molding |
| | (μm) | (m²/g) | (mAh/g) | (%) | (° C.) | (h) | (ppm) | (ppm) | F/Li | (mm) |
| Example 1 | 18.0 | 0.20 | 168 | 97.2 | 800 | 5 | 5100 | 1650 | 3.09 | 15 |
| Example 2 | 17.2 | 0.15 | 170 | 97.0 | 850 | 3 | 5900 | 1900 | 3.11 | 20 |
| Example 3 | 15.1 | 0.32 | 167 | 96.5 | 800 | 4 | 2315 | 550 | 4.21 | — |
| Example 4 | 10.8 | 0.30 | 165 | 96.0 | 800 | 8 | 5250 | 1400 | 3.75 | — |
| Example 5 | 17.2 | 0.31 | 165 | 96.2 | 800 | 10 | 10500 | 7050 | 1.49 | — |
| Example 6 | 16.2 | 0.35 | 165 | 96.1 | 800 | 6 | 8000 | 2050 | 3.90 | — |
| Example 7 | 10.1 | 0.42 | 158 | 96.4 | 700 | 5 | 14000 | 6000 | 2.33 | 20 |
| Example 8 | 15.0 | 0.28 | 157 | 96.2 | 700 | 5 | 3500 | 3600 | 0.97 | 15 |
| Example 9 | 14.2 | 0.52 | 151 | 96.5 | 750 | 5 | 1755 | 3750 | 0.47 | 12 |
| Example 10 | 0.7 | 1.89 | 148 | 96.2 | 750 | 5 | 15000 | 3150 | 4.84 | 10 |
| Example 11 | 28.9 | 0.11 | 148 | 96.0 | 700 | 5 | 600 | 5000 | 0.12 | 5 |
| Example 12 | 15.0 | 0.27 | 149 | 95.0 | 700 | 5 | 7700 | 2600 | 2.96 | 2 |
| Comparative | 0.3 | 2.11 | 138 | 93.0 | 900 | 0.5 | 15050 | 2750 | 5.47 | 4 |
| Example 1 | | | | | | | | | | |
| Comparative | 32.1 | 0.08 | 137 | 92.1 | 950 | 20 | 400 | 5100 | 0.08 | 5 |
| Example 2 | | | | | | | | | | |
| Comparative | 15.0 | 0.28 | 136 | 91.0 | 940 | 8 | 50 | 7600 | 0.01 | 6 |
| Example 3 | | | | | | | | | | |
| Comparative | 13.5 | 0.28 | 133 | 90.6 | 650 | 8 | 450 | 400 | 1.13 | 8 |
| Example 4 | | | | | | | | | | |
| Comparative | 14.2 | 0.22 | 137 | 90.5 | 650 | 8 | 15200 | 2950 | 5.15 | 7 |
| Example 5 | | | | | | | | | | |

As can be seen from Table 1, higher discharge capacity and higher cycle characteristics were obtained in the coin-shaped non-aqueous electrolyte secondary battery prepared by using each lithium-cobalt-based composite oxide of Examples 1 to 11, in which fluoride ions were eluted to an eluate from the composite dispersed to ultrapure water in the mass ratio of 500 ppm or more and 15000 ppm or less in comparison with the lithium-cobalt-based composite oxide, compared to the coin-shaped non-aqueous electrolyte secondary battery prepared by using each lithium-cobalt-based composite oxide of Comparative Examples 1 to 5, in which fluoride ions were eluted to an eluate from the composite dispersed to ultrapure water in the mass ratio of less than 500 ppm or more than 15000 ppm in comparison with the lithium-cobalt-based composite oxide.

It is to be noted that the present invention is not limited to the foregoing embodiment. The embodiment is just an exemplification, and any examples that have substantially the same feature and demonstrate the same functions and effects as those in the technical concept described in claims of the present invention are included in the technical scope of the present invention.

1-16. (canceled)

17. A lithium-cobalt-based composite oxide used for a positive electrode active material of an electrochemical device,
wherein the lithium-cobalt-based composite oxide has elutable fluoride ions, the elutable fluoride ions being eluted to an eluate from the lithium-cobalt-based composite oxide when the lithium-cobalt-based composite oxide is dispersed to ultrapure water, in a mass ratio of 500 ppm or more and 15000 ppm or less in comparison with the lithium-cobalt-based composite oxide, and
the lithium-cobalt-based composite oxide has a composition shown by the following general formula (1):
Li₁₋ₓCo_{1-z}M_{z}O₂₋ₐFₐ (−0.1≦x<1, 0≦z<1, 0≦a<2) (1)
(wherein, M represents one or more kinds of metal element selected from the group of Mn, Ni, Fe, V, Cr, Al, Nb, Ti, Cu, and Zn).

18. The lithium-cobalt-based composite oxide according to claim 17, wherein the lithium-cobalt-based composite oxide has elutable lithium ions, the elutable lithium ions being eluted to an eluate from the lithium-cobalt-based composite oxide when the lithium-cobalt-based composite oxide is dispersed to ultrapure water, in a mass ratio of 500 ppm or more and 20000 ppm or less in comparison with the lithium-cobalt-based composite oxide.

19. The lithium-cobalt-based composite oxide according to claim 17, wherein the lithium-cobalt-based composite oxide has elutable lithium ions and the elutable fluoride ions, the elutable lithium ions and the elutable fluoride ions being eluted to an eluate from the lithium-cobalt-based composite oxide dispersed to ultrapure water, in a mass ratio (the mass of the fluoride ions/the mass of the lithium ions) of 0.1 or more and 5 or less.

20. The lithium-cobalt-based composite oxide according to claim 18, wherein the lithium-cobalt-based composite oxide has elutable lithium ions and the elutable fluoride ions, the elutable lithium ions and the elutable fluoride ions being eluted to an eluate from the lithium-cobalt-based composite oxide dispersed to ultrapure water, in a mass ratio (the mass of the fluoride ions/the mass of the lithium ions) of 0.1 or more and 5 or less.

21. The lithium-cobalt-based composite oxide according to claim 17, wherein the lithium-cobalt-based composite oxide has an average particle size of 0.5 μm or more and 30.0 μm or less.

22. The lithium-cobalt-based composite oxide according to claim 18, wherein the lithium-cobalt-based composite oxide has an average particle size of 0.5 μm or more and 30.0 μm or less.

23. The lithium-cobalt-based composite oxide according to claim 19, wherein the lithium-cobalt-based composite oxide has an average particle size of 0.5 μm or more and 30.0 μm or less.

24. The lithium-cobalt-based composite oxide according to claim 20, wherein the lithium-cobalt-based composite oxide has an average particle size of 0.5 μm or more and 30.0 μm or less.

25. The lithium-cobalt-based composite oxide according to claim 17, wherein the lithium-cobalt-based composite oxide has a BET specific surface area of 0.10 m²/g or more and 2.00 m²/g or less.

26. A method for producing a lithium-cobalt-based composite oxide having a composition shown by the following general formula (1):
Li₁₋ₓCo_{1-z}M_{z}O₂₋ₐFₐ (−0.1≦x<1, 0≦z<1, 0≦a<2) (1)
(wherein, M represents one or more kinds of metal element selected from the group of Mn, Ni, Fe, V, Cr, Al, Nb, Ti, Cu, and Zn), comprising the step of:
mixing and then reacting a lithium compound and a lithium-cobalt-based composite oxide-precursor which has a composition shown by the following general formula (2) with the lithium being extracted:
Li_{1-y}Co_{1-z}M_{z}O_{2-b}F_{b} (x<y≦1, 0≦z<1, 0≦b<2) (2)
(wherein, M represents one or more kinds of metal element selected from the group of Mn, Ni, Fe, V, Cr, Al, Nb, Ti, Cu, and Zn),
wherein, by using as the lithium-cobalt-based composite oxide-precursor and/or the lithium compound the precursor and/or the lithium compound containing fluorine, the produced lithium-cobalt-based composite oxide has elutable fluoride ions, the elutable fluoride ions being eluted to an eluate when the produced lithium-cobalt-based composite oxide is dispersed to ultrapure water, in a mass ratio of 500 ppm or more and 15000 ppm or less in comparison with the lithium-cobalt-based composite oxide.

27. The method for producing a lithium-cobalt-based composite oxide according to claim 26, wherein the lithium-cobalt-based composite oxide-precursor is a lithium-cobalt-based composite oxide-precursor in which the lithium is extracted electrochemically.

28. The method for producing a lithium-cobalt-based composite oxide according to claim 26, wherein the lithium-cobalt-based composite oxide-precursor is a lithium-cobalt-based composite oxide-precursor in which the lithium is extracted electrochemically after molding the lithium-cobalt-based composite oxide-precursor so as to have a thickness of 1.0 mm or more.

29. The method for producing a lithium-cobalt-based composite oxide according to claim 26, wherein the lithium compound contains lithium hexafluorophosphate (LiPF₆).

30. The method for producing a lithium-cobalt-based composite oxide according to claim 26, wherein the lithium compound contains lithium tetrafluoroborate (LiBF₄).

31. The method for producing a lithium-cobalt-based composite oxide according to claim 26, wherein the reacting step includes a baking stage, and in the baking stage, the baking temperature is 600° C. or more and 1100° C. or less.

32. The method for producing a lithium-cobalt-based composite oxide according to claim 26, wherein the reacting step includes a baking stage, and
the baking stage is performed in the atmosphere.

33. An electrochemical device, comprising:
a negative electrode composed of a negative electrode current collector and a negative electrode active material layer containing a particle of negative electrode active material that has charge/discharge efficiency of 80% or less when the particle of negative electrode active material is used as a negative electrode active material for the electrochemical device; and
a positive electrode composed of a positive electrode current collector and a positive electrode active material layer containing the lithium-cobalt-based composite oxide according to claim 17.

34. An electrochemical device, comprising:
a negative electrode composed of a negative electrode current collector and a negative electrode active material layer containing a particle of negative electrode active material that contains silicon oxide shown by the composition formula of SiOₓ (0.5≦x<1.6); and
a positive electrode composed of a positive electrode current collector and a positive electrode active material layer containing the lithium-cobalt-based composite oxide according to claim 17.

35. A lithium ion secondary battery, comprising:
a negative electrode composed of a negative electrode current collector and a negative electrode active material layer containing a particle of negative electrode active material that has charge/discharge efficiency of 80% or less when the particle of negative electrode active material is used as a negative electrode active material for the lithium ion secondary battery; and
a positive electrode composed of a positive electrode current collector and a positive electrode active material layer containing the lithium-cobalt-based composite oxide according to claim 17.

36. A lithium ion secondary battery, comprising:
a negative electrode composed of a negative electrode current collector and a negative electrode active material layer containing a particle of negative electrode active material that contains silicon oxide shown by the composition formula of SiOₓ (0.5≦x<1.6); and
a positive electrode composed of a positive electrode current collector and a positive electrode active material layer containing the lithium-cobalt-based composite oxide according to claim 17.
